(19) United States
(12) Patent Application Publication
(10) Pub. No.: US 2014/0218620 A1
(43) Pub. Date: Aug. 7, 2014

(54) METHODS AND APPARATUS FOR AUTOMATICALLY CONFIGURING A REMOTE CONTROL DEVICE

(71) Applicants: Jason Tyler Griffin, Kitchener (CA); Mihal Lazaridis, Waterloo (CA)

(72) Inventors: Jason Tyler Griffin, Kitchener (CA); Mihal Lazaridis, Waterloo (CA)

(73) Assignee: Research in Motion Limited

(21) Appl. No.: 13/634,762

(22) PCT Filed: Sep. 29, 2011
(86) PCT No.: PCT/CA11/01095

§ 371 Date: Sep. 13, 2012

(51) Int. Cl. H04N 5/44

(52) U.S. Cl. CPC H04N 5/4403
USPC 348/734

(57) ABSTRACT

There is disclosed one or more methods, devices, systems and components therefor to remotely control a media system. A second electronic device may be configured, with remote control codes for at least one component of the media system, by a first electronic device connected to the media system. The first electronic device is connected to the media system via a media interface and is configured to determine the remote control codes from an identification of at least one component of the system. The media interface may be a high definition media interface (HDMI) to identify the connected components. The first and second electronic devices are configured to communicate the codes to configure the second electronic device. The automatic code communication may be responsive to a Bluetooth connection. The first electronic device and second electronic device may each comprise a tablet or a smartphone.

### FIELD

The present matter relates to a device and method for automatically configuring a remote control device with codes for controlling components of a media system and further relates to the automatically configured remote control device.

### BACKGROUND

Electronic devices such as smartphones, tablets and other computing devices may be connected to one or more components of a media system typically as a content source for playing media and/or presenting other content via such components. The components typically have one or more controls such as volume, power, source selection (e.g. input source, channel, etc.) and signal or presentation quality controls, among others. Often such controls may be operated remotely via a wireless remote control device using applicable remote control codes.

### BRIEF DESCRIPTION OF THE DRAWINGS

In order that the subject matter may be readily understood, embodiments are illustrated by way of examples in the accompanying drawings, in which:

FIG. 1 is a block diagram illustrating an example system including components of a media system, a first electronic device such as a tablet and a second electronic device such as a smartphone, in accordance with one example embodiment; and

FIGS. 2, 3 and 4 are respective flowcharts showing methods for automatically configuring the second electronic device as a remote control device for operating components of the media system; and

FIG. 5 is a block diagram illustrating components of an electronic device according to one example embodiment.

For convenience, like numerals in the description refer to like structures in the drawings.

### DETAILED DESCRIPTION

It would be useful to connect one personal electronic device as a content source to a media system and remotely control the media system components via a second personal electronic device. It would also be useful to automatically configure the second personal electronic device with applicable remote control codes. There is disclosed a method and a device for automatically configuring another electronic device as a remote control. There is also disclosed an electronic device that is automatically configured with remotely control codes by another electronic device.

A second electronic device may be automatically configured, with remote control codes for at least one component of the media system by a first electronic device connected to the media system. The first electronic device is connected to the media system via a media interface and is configured to automatically determine the remote control codes from an identification of at least one component via the media interface. The media interface may be a high definition media interface (HDMI™, (HDMI is a registered trademark of HDMI LICENSING, L.L.C.)). The first electronic device and second electronic device are configured to automatically communicate the codes to the second electronic device. The automatic code communication may be responsive to a short range communication connection to configure the second electronic device automatically when the first electronic device and second electronic device are proximate to each other. The first electronic device and second electronic device may each be a tablet or a smartphone, for example.

According to an aspect, disclosed is a method of automatically configuring a remote control device. The method includes automatically determining an identification of one or more components of a media system connected to a first electronic device; determining remote control codes in accordance with the identification; automatically communicating the remote control codes to a second electronic device configured to remotely control media system components.

Automatically determining the identification may include obtaining the identification in accordance with an interface protocol for a media interface coupling the first electronic device and the media system. The media interface may include a high definition media interface (HDMI).

Determining remote control codes may include communicating with a remote store of codes via a network. It may include storing such codes locally in the memory of the first electronic device, in order to later perform a local lookup.

Automatically communicating the codes may include pushing the remote control codes to the second electronic device, such as via a wireless communication. In one example embodiment, the remote control codes are pushed automatically in response to a short range communication connection (e.g. Bluetooth™ (Bluetooth is a registered trademark of Bluetooth SIG, Inc.)).

In a second aspect there is provided, a first electronic device for automatically configuring a second electronic device for remotely controlling a media system, the first electronic device including at least one media interface for coupling to one or more components of the media system; a communication interface for communicating with the second electronic device; and a processor and memory storing instructions for configuring the execution of processor to: automatically determine an identification of one or more components of the media system connected to the media interface; determine remote control codes in accordance with the identification; and automatically communicate the remote control codes to the second electronic device for use to remotely control media system components.

There is provide a method of remotely controlling at least one component of a media system including: communicatively coupling a first electronic device and a second electronic device, the first electronic device configured to automatically determine remote control codes for the at least one component, the second electronic device configured for remotely controlling media systems; automatically receiving and storing remote control codes from the first electronic device in response to the coupling; and selectively transmitting the remote control codes wirelessly from the second electronic device to control the at least one component of media system.

The first electronic device and second electronic device may be communicatively connected via a short range wireless connection. The second communication device may automatically receive the remote control codes via a pushed communication from the first electronic device. The remote control codes may be automatically received in response to a Bluetooth connection.

There is provided an electronic device for remotely controlling at least one component of a media system. The electronic device includes a first communication interface for automatically receiving remote control codes from another electronic device communicatively connected to the media system, the other electronic device configured to automatically determine the remote control codes in accordance with the identification of the at least one component and automatically communicate the codes to the electronic device; a second communication interface for wirelessly communicating remote control codes to the media system; and a processor and memory for storing the remote control codes and providing a user interface for selectively transmitting the remote control codes via the second communication interface.

These and other aspects such a as a computer program product will be apparent to those of skill in the art.

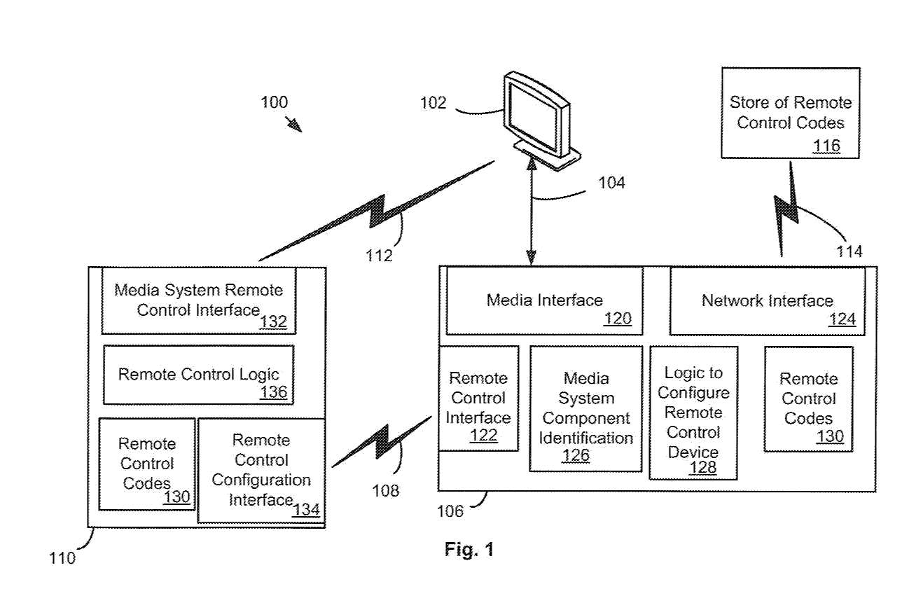

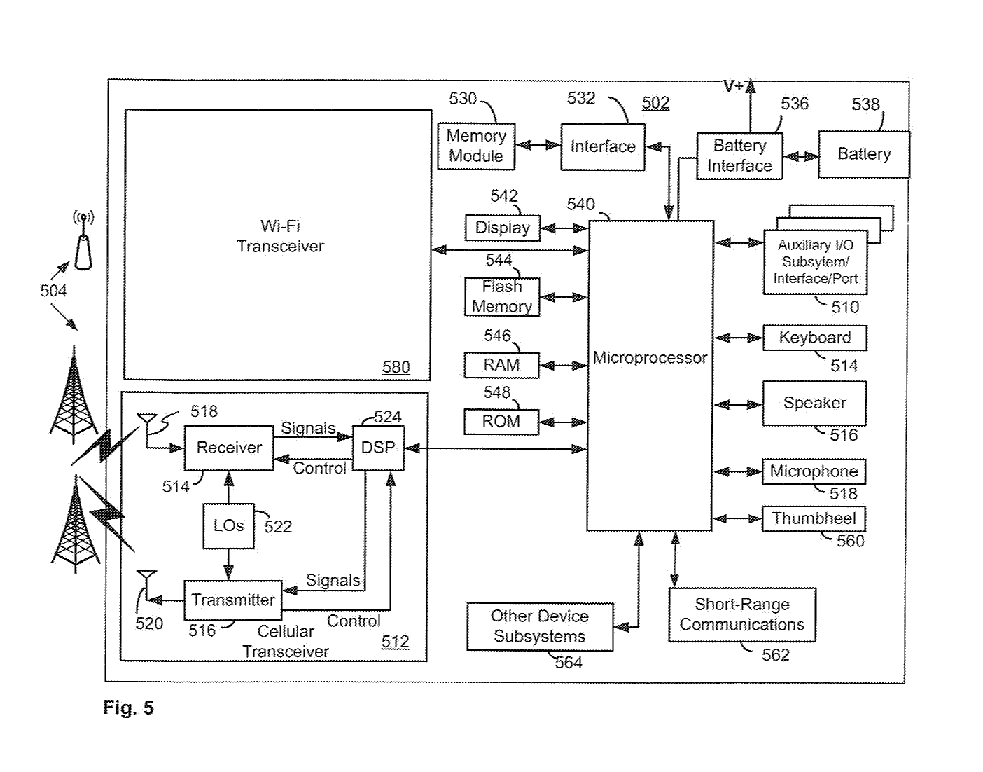

FIG. 1 is a block diagram illustrating a system 100, as an example, including components of a media system 102 such as home theatre system, a first electronic device 106 such as a tablet and a second electronic device 110 such as a smartphone, connected for operation in accordance with one example embodiment. In an example embodiment, first electronic device 106 may be configured as a media or other content source device for providing content to media system 102. First electronic device 106 is further configured to automatically configure second electronic device 110 as a remote control device for controlling at least some of the controls of the media system 102. It will be apparent that system 100 is simplified and that, in particular, components of the first electronic device 106 and second electronic device 110 are omitted. An example electronic device is further described with respect to FIG. 5.

As a home theatre system, media system 102 may include one or more of a television and/or monitor, an audio system (e.g. amplifier and speakers), DVD player, VCR, TV signal set top box (e.g. IPTV, cable or satellite box), etc. Media system 102 is communicatively connected to first electronic device 106 via link 104 such as a high definition media interface (HDMI) cable to media interface 120. Other links, cabling, media interfaces, audio/video interfaces and other interfaces may be utilized. For example, an Ethernet cable and Internet Protocol (IP) interface may be adopted for a cooperatively configured component of the media system 102.

First electronic device 106 is communicatively connected to second electronic device 110 via first wireless link 108 and remote control interface 122. Second electronic device 110 is communicatively connected to media system 102 via second wireless link 112 and media system remote control interface 132.

In an example embodiment, system 100 further includes a store 116 of remote control codes. First electronic device 106 is communicatively connected to store 116 via third wireless link 114 and network interface 124.

First electronic device may obtain data 126 providing media system component identification (e.g. data identifying a make and model of at least some of the components of media system 102). Data 126 may be obtained from media system 102 via media interface 120 and link 104. Such data 126 may be made available automatically such as in accordance with one or more communication channel protocols by which first electronic device 106 and media system 102 communicate. By way of example, HDMI is one such interface which enables this information to be received by first electronic device 106. Though only one link 104 is shown, electronic device 106 may connect to media system 102 via two or more such links (e.g. first cable, second cable and so on).

First electronic device 106 includes logic 128 to automatically determine applicable codes and configure the remote control device (e.g. 110). Logic 128 may be configured to utilize data 126 to obtain specific remote control codes 130 (e.g. one or more data sets) for the identified components of media system 102. First electronic device 106 may communicate via network interface 124 and wireless link 114 with store 116 to obtain the specific remote control codes 130. Store 116 may be provided by a service provider and/or manufacturer(s) of the media system components. More than one store 116 may be provided (not shown). Store 116 may be configured as a Web Service or other service using Web-based protocols, for example. Store 116 may be configured as a data lookup.

In an example embodiment, first electronic device 106 may locally store in its memory a plurality of data sets for many makes and models (not shown) from which the specific remote control codes 130 may be determined. For example, electronic device 106 may be pre-programmed with such data sets. In one example embodiment, first electronic device 106 may look locally first and then obtain it from store 116 if necessary.

First electronic device 106 communicates the specific remote control codes 130 via remote control interface 122 and wireless link 108 to second electronic device 110. Second electronic device 110 receives from the first electronic device 106 and stores the specific remote control codes 130 via remote control configuration interface 134 and wireless link 108. First electronic device 106 and second electronic device 110 may be paired for such communication in accordance with Bluetooth protocols, for example. In accordance with Bluetooth operations, when the first electronic device 106 and second electronic device 110 are sufficiently proximate, and paired, a connection may be automatically established and the first electronic device 106 and second electronic device 110 can communicate the specific remote control codes 130 automatically.

In an example embodiment, first electronic device 106 may communicate data 126 via remote control interface 122 and wireless link 108 to second electronic device 110. As such, the determination of the specific remote control codes 130 need not be performed on behalf of second electronic device 110. Second electronic device 110 may communicate with store 116 (not shown in FIG. 1) or locally store in its memory code data sets (not shown in FIG. 1) from which the specific remote control codes 130 may be determined by the second electronic device.

In an example embodiment, first electronic device 106 may communicate additional information to the data 126 or specific remote control codes 130. For example, text or other information may be communicated for use in a user interface of the remote control logic 136 to assist with remote control of specific components of the media system 102.

Second electronic device 110 includes remote control logic 136, which utilizes the specific remote control codes 130 for controlling at least some of the components of media system 102. Remote control logic 136 may include a user interface (not shown) for receiving user input to selectively communicate the applicable remote control code from specific remote control codes 130 to control the media system 102. Remote control logic 136 communicates the applicable remote control code through media system remote control interface 132 and wireless link 112 to command and/or configure the components accordingly. The user interface may include one or more screens for the various components to be controlled. Media system remote control interface 132 may include an infrared (IR) communication interface or a radio interface (e.g. UHF). In one example embodiment, remote control logic 136 is configured as an application for second electronic device 110 and logic 128 is configured as an application for first electronic device 106. In an example embodiment, a single application may be configured with remote control code configuring features for both devices such that depending on which physical device is used as the first and second device, respective operations to configure a paired electronic device or to operate as a configured remote control may be performed. It is understood that the application(s) may be installed on the applicable devices such as by downloading an application package from a remote store of applications (not shown in FIG. 1) among other ways.

In an alternative example embodiment, first electronic device 106 may include a set top box for example, configured to receive TV signals (e.g. cable, satellite, IPTV, etc.) and/or digital media streaming. The set top box preferably is configured with Internet connectivity and short range communications to connect with an electronic device to be configured as a remote control device.

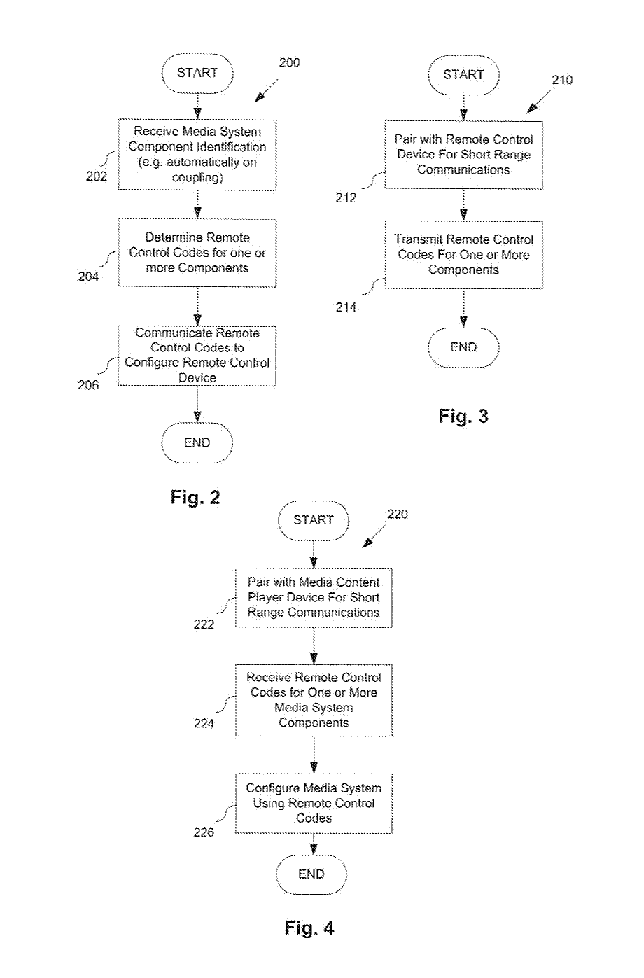

FIG. 2 is a flowchart showing methods 200 of first electronic device 106 for automatically configuring second electronic device 110 as a remote control device for operating components of the media system 102. At 202, media system component identification (e.g. data 126) is received. The data 126 may be received by first electronic device 106 in accordance with interface specifications when the component of media system 102 and first electronic device 106 are connected and powered. First electronic device 106 may detect the coupling and obtain (e.g. automatically receive and/or inquire and receive) data 126 in accordance with the interface specifications.

At 204, data 126 is utilized to determine specific remote control codes 130 for any of the identified components. For example, a remote lookup of store 116 may be performed to determine (e.g. lookup/receive and store) the specific remote control codes 130. The codes may include data for infrared (IR) on radio commands. The specific remote control codes 130 may be stored in memory such that upon a next power up and identification of components, they are available locally without need for a remote lookup. In another example embodiment, a plurality of code data sets is pre-programmed and a local lookup of code data sets stored in memory is performed to determine the specific remote control codes 130.

At 206, specific remote control codes 130 are communicated to configure the second electronic device 110 (e.g. as a remote control device).

FIG. 3 is a flowchart illustrating methods 210 for communicating between first electronic device 106 and second electronic device 110. At 212, first electronic device 106 performs its obligations to pair for communication with second electronic device 110, as is well known. Pairing may be performed out of sequence to methods 200, meaning before or during methods 200.

At 214, specific remote control codes 130 are transmitted. For example, in the presence of a connection, first electronic device 106 may detect the connection and automatically “push” (i.e. transmit) specific remote control codes 130 to the second electronic device 110.

FIG. 4 is a flowchart illustrating methods 220 for communicating between first electronic device 106 and second electronic device 110. At 222, second electronic device 110 performs its obligations to pair for communication with first electronic device 106, as is well known. Pairing may be performed out of sequence to methods 200, meaning before or during methods 200.

At 224, specific remote control codes 130 are received by the second electronic device 110 and stored. For example, in the presence of a connection, second electronic device 110 may automatically receive via push the specific remote control codes 130.

In some example embodiments, second electronic device 110 may detect the connection and “pull” (i.e. receive) specific remote control codes 130 from electronic device 106.

At 226, second electronic device 110 remotely controls (i.e. configures) at least one component of media system 102. The applicable remote control code or codes is selectively communicated via interface 132 and wireless link 112 for example in response to user input (not shown in FIG. 1).

It is understood that the second electronic device 110 may receive remote control codes for TV and other component functions. Remote control logic 136 may be configured for universal remote capabilities, to be configurable to operate various makes and models of components. In some example embodiments, not shown, the remote control logic 136 may be customizable by a user.

Though not shown in illustration of the methods of FIGS. 2-4, second electronic device 110 may determine the specific remote control codes 130 from component identification data (e.g. data 126) received from first electronic device 106.

First electronic device 106 and second electronic device 110 may communicate remote codes via other communication networks and/or protocols such as by Wi-Fi or via a serial bus connection.

Persons of skill in the art will recognize that the first electronic device 106 and second electronic device 110 of FIG. 1 may be configured from various computing and/or communication devices. For example, FIG. 5 shows a block diagram illustrating an example electronic communication device 502 that is suitable to be configured as electronic device 106 or 110. Device 502 is illustrated with wireless communication capabilities and in particular example embodiments communicates through a communication network 504. Network 504 is also illustrated with wireless capabilities and includes antenna, base stations, and supporting radio equipment for supporting wireless communications between device 502 and other devices connected to network 504. Network 504 may be connected to a network gateway and to a wide area network (not shown).

In one example embodiment, device 502 is a two-way communication device having at least data and/or voice communication capabilities, including the capability to communicate with other computer systems. In particular example embodiments, device 502 is a mobile device. Depending on the functionality provided by device 502, it may be a data messaging device, a two-way pager, a cellular telephone with data messaging capabilities, a wireless Internet appliance, a data communication device (with or without telephony capabilities), a smartphone, personal digital assistant, a portable media, a music player, a tablet or a laptop. In some example embodiments device 502 is a desktop computer or a server. More generically, it may be a computing device.

Device 502 may communicate with any one of a plurality of fixed transceiver stations within its geographic coverage area. Though a wireless device is shown, in some example embodiments device 502 may have a wire connection to network 504.

Device 502 may incorporate one or more communication subsystems such as subsystems 512 and/or 580. Communications subsystem 580 may be a wireless networking communications subsystem, for example, conforming to IEEE 802.51 standards such as 802.51b, 802.51g, and/or 802.51n and/or others. In some example embodiments, subsystem 580 is only present and communications subsystem 512 providing cellular communications is not. In some example embodiments, subsystem 512 may be removably connected to a port of device 502 such as via a USB stick. In an example, communication subsystem 512 includes a receiver 514, a transmitter 516, and associated components, such as one or more antenna elements (518 and 520), local oscillators (LOs) 522, and a processing module such as a digital signal processor (DSP) 524. In one example embodiment, antenna elements (518 and 520) may be embedded or internal to device 502. As will be apparent to those skilled in the field of communications, the particular design of the communication subsystem 512 depends on the network 504 in which device 502 is intended to operate.

Device 502 may send and receive communication signals over the network 504 after network registration or activation procedures have been completed. Signals received (e.g. by antenna elements 518) through network 504 are input to receiver 514, which may perform such common receiver functions as signal amplification, frequency down conversion, filtering, channel selection, etc., as well as analog-to-digital (ND) conversion. ND conversion of a received signal allows more complex communication functions such as demodulation and decoding to be performed in DSP 524. In a similar manner, signals to be transmitted are processed, including modulation and encoding, for example, by DSP 524. These DSP-processed signals are input to transmitter 516 for digital-to-analog (D/A) conversion, frequency up conversion, filtering, amplification, and transmission to the network 504 via antenna 520. DSP 524 processes communication signals and provides for receiver and transmitter control. For example, the gains applied to communication signals in receiver 514 and transmitter 516 may be adaptively controlled through automatic gain control algorithms implemented in DSP 524.

Network access (WAN) may be associated with a subscriber or user of device 502 via a memory module, such as a memory module 530, which may be a Subscriber Identity Module (SIM) card for use in a GSM network or a USIM card for use in a UMTS. The SIM card is inserted in or connected to an interface 532 of device 502 in order to operate in conjunction with network 504. Alternatively, device 502 may have an integrated identity module for use with systems such as Code Division Multiple Access (CDMA) systems. Device 502 may include a Wi-Fi transceiver 580 that may include similar components/chipsets to communication subsystem 512 adapted for one or more Wi-Fi protocols. Though Wi-Fi is shown, WiMAX is one alternative transceiver. In some example embodiments, device 502 may be capable of Wi-Fi and WiMAX communications in accordance with software-defined radio (“cognizant radio”) techniques.

Device 502 also includes a battery interface 536 for receiving one or more battery 538 which may be rechargeable. The one or more battery 538 provides electrical power to at least some of the electrical circuitry in device 502, and battery interface 536 provides a mechanical and electrical connection for the one or more battery 538. Battery interface 536 is connected to a regulator (not shown) which provides power V+ to the circuitry of device 502.

Device 502 includes a programmable processor (e.g. microprocessor 540) which controls the overall operation of device 502. Communication functions, including at least data and voice communications, are performed through the communication subsystem 512. Microprocessor 540 also interacts with additional device subsystems such as a display 542, a flash memory 544, a random access memory (e.g. RAM 546), a read-only memory (e.g. ROM 548), input/output (I/O) subsystems, interfaces or ports 510 (e.g. an audio port for connecting to a set of headphones and/or a remote microphone, an High-Definition Multimedia Interface (HDMI), composite video, component video, S-Video, etc, a Universal Serial Bus (USB) or Ethernet port), a keyboard or keypad 514, a speaker 516, a microphone 518, a clickable thumbwheel, trackball, optical or other touch or gesture based input pad, or set of scroll buttons, etc. 560, typically for scrolling/selecting input, one or more short-range communications subsystems 562, and any other device subsystems generally designated as 564. Some of the subsystems shown in FIG. 5 perform communication-related functions, whereas other subsystems may provide “resident” or on-device functions.

Some subsystems, such as keypad 514, display 542, and input device 560, for example, may be used for communication-related functions, such as entering a text message for transmission over network 504, and executing device-resident functions such as a calculator or task list, media play back, Internet browsing, etc. Operating system software and other software used by the microprocessor 540 is preferably stored in a persistent store such as flash memory 544, which may alternatively be ROM 548 or similar storage element. Those skilled in the art will appreciate that the operating system, specific device applications, or parts thereof, may be temporarily loaded into a volatile store such as RAM 546.

The microprocessor 540, in addition to its operating system functions, enables execution of software applications on device 502. A predetermined set of applications that control basic device operations, including data and voice communication applications, will normally be installed on device 502 during or after manufacture. One or more memory stores may be available on device 502 to facilitate storage of information, such as flash memory 544, RAM 546, ROM 548, memory module 530, or other types of memory storage devices or FLASH memory cards represented by other device subsystems 564, such as Secure Digital (SD) cards, mini SD cards, micro SD cards, etc.

Device 502 may be configured with a browser for interacting with Web pages. Device 502 may have one or more media related applications for displaying images, playing audio and or video files/streams, etc. The browser and/or media applications often have the ability to send and receive data items via either network 504 or a link to a computer system. The link to the computer system may be via serial port (e.g. 510) or short-range communications subsystem 562. Additional applications may also be loaded onto device 502 through network 504, auxiliary I/O subsystems/interfaces/ports 510, short-range communications subsystem 562, or possibly, other device subsystems 564, and installed by a user in RAM 546 or a non-volatile store such as ROM 548 for execution by microprocessor 540. Such flexibility in application installation increases the functionality of device 502 and may provide enhanced on-device functions, communication-related functions, or both. For example, secure communication applications may enable electronic commerce functions and other such financial transactions to be performed using device 502.

A data signal representing remote control codes may be received or transmitted by communication subsystem 512, transceiver 580 or short range communications 562. A short range or other communication means (e.g. radio or IR transmitter (not shown)) may be connected to device 502 via serial or other port. The microprocessor 540 may further process a received data signal. For example, as a device 110, microprocessor 540 may store the specific remote control codes 130 used to configure media system 102, selectively transmitting the applicable remote control code via short range communications 562 as IR codes, under control of a user, for example. A user of device 110 may selectively input commands for configuring the controls of the media system such as changing volume, playback quality controls, power, etc., for example, using keypad 514 and/or input device 560 or a touch screen configured display 542 and possibly auxiliary I/O subsystem 510, Keypad 514 may be either a complete alphanumeric keypad or telephone-type keypad.

A serial port (e.g. 510) is often implemented (e.g. in a personal digital assistant (PDA) type communication device for which synchronization or other communication with a user's computer is a useful, but optional, component). A serial port enables a user to set preferences through an external device or software application and extends the capabilities of device 502 by providing for information, media file, or software downloads to or uploads from device 502 other than through network 504. It may also accept other communication devices such as radio and IR dongles.

Short-range communications subsystem 562 is an additional component which provides for communication between device 502 and different systems or devices, which need not necessarily be similar devices. For example, short-range communications subsystem 562 may include an infrared (IR) device and associated circuits and components, or a wireless bus protocol compliant communication mechanism such as a Bluetooth communication module to provide for communication with similarly-enabled systems and devices. Device 502 may be configured to pair with other Bluetooth compliant devices for establishing communications.

The scope of the claims should not be limited by the example embodiments described herein, but should be given the broadest interpretation consistent with the description as a whole.

What is claimed is:

1. A method of configuring a remote control device comprising:
determining an identification of one or more components of a media system connected to a first electronic device;
determining remote control codes based on the identification; and
communicating the remote control codes to a second electronic device configured to remotely control media system components.

2. The method of claim 1 wherein determining the identification comprises obtaining the identification based on an interface protocol for a media interface coupling the first electronic device and the media system.

3. The method of claim 2 wherein the media interface comprises a high definition media interface (HDMI).

4. The method of claim 1 wherein determining remote control codes comprises communicating with a remote store of codes via a network.

5. The method of claim 1 wherein communicating comprises pushing the remote control codes to the second electronic device.

6. The method of claim 5 wherein the remote control codes are pushed over a wireless communication.

7. The method of claim 6 wherein the remote control codes are pushed in response to a Bluetooth connection.

8. A first electronic device to configure a second electronic device to remotely control a media system, the first electronic device comprising at least one media interface to connect to at least one component of the media system; a communication interface to communicate with the second electronic device; and a processor and memory storing instructions to configure the processor to:
determine an identification of one or more components of the media system connected to the media interface;
determine remote control codes based on the identification; and
communicate the remote control codes to the second electronic device to use to remotely control media system components.

9. The first electronic device of claim 8 wherein to determine the identification comprises obtaining the identification based on an interface protocol for the media interface coupling the system and the media system.

10. The first electronic device of claim 9 wherein the media interface comprises a high definition media interface (HDMI).

11. The first electronic device of claim 8 wherein communicating comprises pushing the remote control codes to the second electronic device.

12. The first electronic device of claim 11 wherein the communication interface comprises a wireless communication interface.

13. The first electronic device of claim 12 wherein the remote control codes are pushed in response to a Bluetooth connection.

14. A method of remotely controlling at least one component of a media system comprising:
communicatively coupling a first electronic device and a second electronic device, the first electronic device configured to determine remote control codes for the at least one component, the second electronic device configured to remotely control at least one component of media systems;
receiving and storing remote control codes from the first electronic device in response to the coupling; and
selectively transmitting the remote control codes wirelessly from the second electronic device to control the at least one component of the media system.

15. The method of claim 14 wherein the first electronic device and second electronic device are communicatively connected via a short range wireless connection.

16. The method of claim 15 wherein the second communication device receives the remote control codes via a pushed communication from the first electronic device.

17. The method of claim 16 wherein the remote control codes are received via a Bluetooth connection.

18. The method of claim 14 wherein the remote control codes comprise data determined in response to an automatic identification of the at least one component by the first electronic device.

19. The method of claim 14 wherein the first electronic device is connected to the media system via a media interface to receive an identification of the at least one component.

20. The method of claim 19 wherein the media interface comprises a high definition media interface (HDMI).

21. An electronic device to remotely control at least one component of a media system, the electronic device comprising:
a first communication interface to receive remote control codes from an other electronic device communicatively connected to the media system, the other electronic device configured to determine the remote control codes based on an identification of the at least one component and communicate the codes to the electronic device;
a second communication interface to wirelessly communicate remote control codes to the media system; and
a processor and memory to store the remote control codes and providing a user interface to selectively transmit the remote control codes via the second communication interface.
